(19) United States
(12) Patent Application Publication
(10) Pub. No.: US 2006/0146756 A1
(43) Pub. Date: Jul. 6, 2006

(54) Downlink resource allocation for time offset downlink packets

(76) Inventors: Fan Wang, Vernon Hills, IL (US); Amitava Ghosh, Buffalo Grove, IL (US); Robert T. Love, Barrington, IL (US)

Correspondence Address: POSZ LAW GROUP, PLC, 12040 SOUTH LAKES DRIVE, SUITE 101, RESTON, VA, 20191, US

(21) Appl. No.: 11/026,141

(22) Filed: Dec. 30, 2004

(51) Int. Cl. H04B 7/216

(52) U.S. Cl. 370/335; 455/522

(57) ABSTRACT

In a network, where a packet is to be transmitted on a channel to a communication device with a time offset between a shared control channel and a shared data channel, the packets can be ordered. A margin (301) can be determined (403) between a power need of a data channel of a packet and a total available transmit power (315) of the network infrastructure device. Scheduling packets (405) is responsive to the margin, and determines the next packet to be sent, where the control channel of the next packet has a power need less than the power margin. Resources are allocated (407) responsive to the margin to further determine the subsequent packet. The subsequent packet is transmitted (411) on the channel, wherein the data channel of the current packet and the control channel of the subsequent packet are at least partially contemporaneous.

### FIELD OF THE INVENTION

The present invention relates in general to wireless communication units and wireless networks, and more specifically to scheduling or allocating resources for packet communications on a wireless network.

### BACKGROUND OF THE INVENTION

Conventional communication technologies can send communications to a communication device on a downlink part of a connection. The downlink provides, among other things, a control channel having control information about the connection, and a data channel with the actual data that is transmitted to the communication device. A packet is transmitted on the connection, where the packet includes both the control and data channels.

New technology has introduced the concept that the control information can begin to be sent to a communication device immediately prior to the transmission of the data on the data channel. The time offset of the transmission of the control information on the control channel can allow the communication device to pre-set itself to properly receive the data on the data channel. This can permit communications to be transmitted at a higher speed.

One of these new technologies is HSDPA (High Speed Downlink Packet Access). HSDPA can support increased data rates and higher capacity in comparison to conventional wireless communications. HSDPA is a new variation of the UMTS (Universal Mobile Telecommunications System) packet data air interface that utilizes time offset transmission. HSDPA can offer access to more content due to the high speed downlink transmission.

HSDPA has various new features to improve speed, including sending packets on frame boundaries, where the frames are reduced to two milliseconds (ms). HSDPA also expands the channel structure to include one or more high speed control channels (HS-SCCH), and introduces a new common high speed downlink shared channel (HS-DSCH) which can be shared by several users. The HS-SCCH can contain control information, e.g., which user equipment is addressed, modulation, coding, and the like, as well as which code channels the data packet that is transmitted a few moments later can be located.

### BRIEF DESCRIPTION OF THE DRAWINGS

The accompanying figures where like reference numerals refer to identical or functionally similar elements and which together with the detailed description below are incorporated in and form part of the specification, serve to further illustrate exemplary embodiments and to explain various principles and advantages in accordance with the present invention.

FIG. 1 is a block diagram illustrating a simplified and representative data flow in an infrastructure device in a wireless network in accordance with various exemplary embodiments;

FIG. 2 is a block diagram illustrating portions of an exemplary network infrastructure device arranged for resource allocation for time offset downlink packets in accordance with various exemplary embodiments;

FIG. 3 is a diagram illustrating an exemplary and simplified representation of a downlink communication in accordance with various exemplary embodiments; and

FIG. 4 is a flow chart illustrating an exemplary procedure for ordering packets for a transmission, in accordance with various exemplary and alternative exemplary embodiments.

### DETAILED DESCRIPTION

In overview, the present disclosure concerns wireless communications systems and devices or units, often referred to as communication units, such as cellular phones or two-way radios and the like, typically having mobile operating capability, such as can be associated with a communication system such as an enterprise network, a cellular Radio Access Network, a third generation cellular system, or the like. Such communication systems may further provide services such as voice and data communications services. More particularly, various inventive concepts and principles are embodied in systems, communication units, and methods therein for controlling allocation and scheduling of resources of a communication network associated with a communication to a communication unit.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor or embedded systems and software therefore, or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

As further discussed herein below, various inventive principles and combinations thereof are advantageously employed to take advantage of the time offset between a control channel and a data channel. With this time offset, the control information can begin to be sent to a communication device immediately prior to the transmission of the data on the data channel. This avoids speculative decoding of the data channel (which would be required if the control and data information were sent at the same time) while minimizing latency associated with the time between transmissions of a given packet. One potential drawback in minimizing the latency is that the frame boundary of control channel frame n and n+1 occurs during the transmission of the data frame n where two different users are assigned to frame n and n+1. Due to this frame overlapping, two control channel transmissions can require significantly different amounts of power over the time interval of the data transmission (e.g. when one user is close to the base station transmitter and the other is far away at the cell edge) such that the scheduler must speculatively account for the worst case power needed for the control channels when determining the power available for the data transmission of frame n. This worst case control channel power overhead can then significantly reduce power available for the data channel and thereby reduce user and system data throughput. This can be a significant problem when multiple communication devices are to be scheduled for each frame interval (which is called code division multiplexing (CDM)). Hence, it is important to somehow account for the control channel power overhead or, more specifically, the control channel power margin between the data channel of a packet (frame n) and the control channel of the subsequent packet (frame n+1) when scheduling and allocating resources (e.g. power, codes). Even without the frame overlap it is still advantageous to somehow account for control channel power overhead in an optimal manner when scheduling and allocating resources. Accordingly, throughput can be improved by utilizing a power margin between the data channel of a packet and the control channel of the subsequent packet.

Further in accordance with exemplary embodiments, the above-mentioned power margin can be determined. A scheduler and/or a resource allocation unit can utilize the power margin in determining an order and/or providing packets to be sent over a communication network.

Referring now to FIG. 1, a block diagram illustrating a simplified and representative data flow in an infrastructure device in a wireless network in accordance with various exemplary embodiments will be discussed and described. In the illustrated example, functional blocks represent a resource allocation unit 101, a scheduler 103, a margin determination unit 107, an eligibility unit 109, and an optional preliminary margin determination unit 105. Alternative exemplary embodiments can omit the scheduler 103 or the resource allocation unit 101, or may combine them. In addition, the optional preliminary margin determination unit 105 can be omitted, or can be a functional unit separate from the resource allocation unit 101.

The scheduler 103 can provide for determining which users to serve, for example, by priority associated therewith, where the priority may be assigned in accordance with conventional techniques for scheduling users. One or more embodiments provides for scheduling which can include determining a priority of users on the network infrastructure device.

The scheduler 103 can utilize a conventional technique for scheduling, e.g., having a proportional fair algorithm, in conjunction with using a margin as determined by the margin determination unit 107. The scheduler 103 advantageously can take into consideration the power margin, so that if a communication device needs more power for transmitting its control channel than the available power margin, the communication device is not scheduled for the next transmission.

For example, for a so-called proportional fair scheduler, a set of communication devices that can be served can be determined, where the channel condition at each of the communication devices within the set is sufficient for reliable reception of HS-SCCH (high speed control channels) (e.g., determined by using the C/I (carrier-to-interference ratio) reported from the communication device). The priority can be determined for the set of communication devices. A data rate potentially achievable for an infrastructure device (used in determining priority) can reference the margin. The scheduler 103 can output, e.g., a sorted list of communication devices, queues thereof, and priorities thereof. Such information can be utilized by, e.g., the resource allocation unit 101.

The resource allocation unit 101 can utilize conventional techniques for devising an appropriate resource allocation among the users determined, e.g., by the scheduler 103, in conjunction with using the margin. For example, the resource allocation unit 101 can utilize an optimal searching technique to maximize the total data channel throughput weighted by the priorities from the scheduler 103 among all communication devices that are feasible and that satisfy a constraint that there is sufficient power assigned for HS-SCCH reliable transmission.

The margin determination unit 107 can determine the power that will be available for sending out the control channel of a packet subsequent to the current packet under consideration, e.g., the packet that was just transmitted. The margin determination unit 107 can consider the total available power for transmission at the network infrastructure device minus the power occupied by the data portion of the current packet (or of the current frame). For example, if the data portion of the packet being sent requires 80% of the total available power, the margin is 20% of the total available power. (It will be appreciated that although margin is described herein as a percentage of power, one or more embodiments can utilize appropriate units of power or other appropriate measurements.)

The eligibility unit 109 can be a conventional program which checks for the communication devices that are eligible for scheduling. Information representing the eligible communication devices can be provided from the eligibility unit 109 to the scheduler 103. Because the functions performed by the eligibility unit 109 are conventional, they are not further described herein.

The optional preliminary margin determination unit 105 can be utilized to predict which frames are likely to be scheduled in advance of their being scheduled, by estimating the power margin of two or more subsequent frames. The resource allocation unit 101 can receive more than one frame of information to be scheduled, hence, the optional preliminary margin determination unit 105 can utilize information representing the remaining packets (which are queued in the presently determined order) to determine a margin for future frames. Because the resource allocation unit 101 can re-order the packets each time they are selected for sending, the preliminary margin determination may not accurately reflect the packets that are actually sent. Advantageously, the preliminary margin determination can be utilized to better allocate resources, as is explained in further detail below.

Accordingly, a network infrastructure device is provided for transmitting packets on a network, where a packet is to be transmitted on one or more code channels to one or more communication devices with a time offset between a shared control channel and a shared data channel. The network infrastructure device has a limited transmit power. The margin determination unit 107 can be provided to determine a margin between a power need of a data channel of one or more first packets and a total available portion of the transmit power. The scheduler 103, responsive to the margin, can be provided to determine one or more users corresponding to one or more second packets to be transmitted, wherein a control channel of the second packet(s) has a power need less than the power margin. The resource allocation unit 101, responsive to the margin and to the scheduler 103, can be provided to perform an allocation of resources including the code channel(s), and further provides the second packet(s). A transmitter on the network infrastructure device (not illustrated), responsive to the resource allocation unit 101, can be provided to transmit the second packet(s). The data channel of the first packet(s) and the control channel of the second packet(s) are at least partially contemporaneous.

The resource allocation unit can utilize the predicted power need in one or more of the subsequent packets to attempt to balance power needs of the respective packets. Power needs can be balanced by, e.g., re-ordering packets so that overall power needs of two or more packets tend toward an average. It will be appreciated that power needs can be determined with reference to the data channel and/or the control channel. Accordingly, one or more embodiments provide that the resource allocation unit can determine a predicted power need of a data channel and/or a control channel of a packet to be sent after the subsequent packet(s), wherein the allocation is further responsive to the predicted power and balances the power need of the subsequent packet(s) and a power need of the packet(s) to be sent thereafter.

In accordance with one or more embodiments, the network in which the network infrastructure device participates can utilize code division multiplexing (CDM). Advantageously, the network can be a high speed downlink packet access (HSDPA) network.

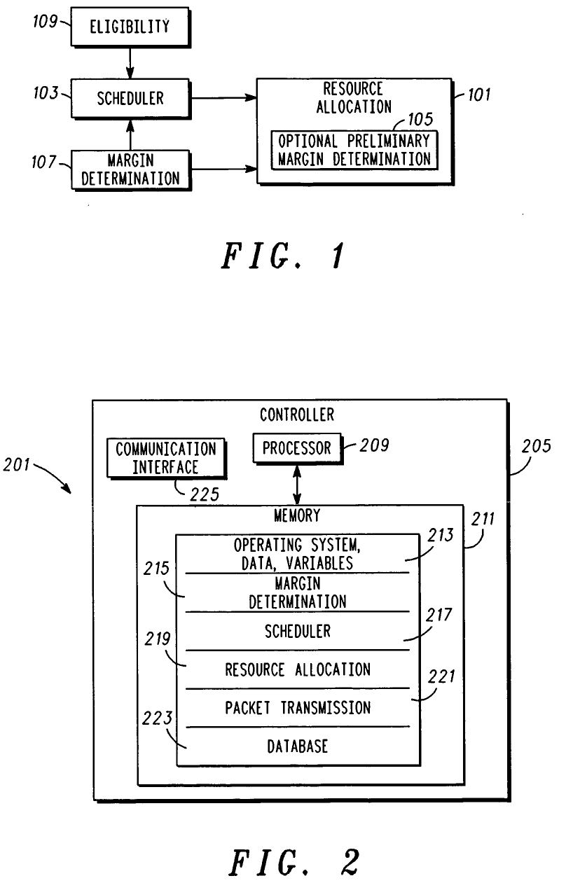

Referring now to FIG. 2, a block diagram illustrating portions of an exemplary network infrastructure device 201 arranged for resource allocation for time offset downlink packets in accordance with various exemplary embodiments will be discussed and described. FIG. 2 is a diagram illustrating an exemplary network infrastructure device 201, such as a base station, in an exemplary communication network, e.g., a radio access network arrangement. The network infrastructure device 201 may include a controller 205, and a communication interface 225 for communicating with, e.g., communication devices. The controller 205 as depicted generally comprises a processor 209, a memory 211, and may include various other functionality that is not relevant but will be appreciated by those of ordinary skill.

The processor 209 may comprise one or more microprocessors and/or one or more digital signal processors. The memory 211 can be coupled to the processor 209 and comprise one or more of a read-only memory (ROM), a random-access memory (RAM), a programmable ROM (PROM), an electrically erasable read-only memory (EEPROM) and/or magnetic memory or the like. The memory 211 may include multiple memory locations for storing, among other things, an operating system, data and variables 213 for overall management of programs executed by the processor 209; computer programs for causing the processor to operate in connection with various functions such as margin determination 215, a scheduler 217, resource allocation 219, and packet transmission 221; and a database 223 for other information used by the processor 209. The computer programs when executed by the processor can direct the processor 209 in controlling the operation of the network infrastructure device.

One or more embodiments of exemplary processes for margin determination 215, the scheduler 217, and the resource allocation 219 have been described previously. The packet transmission 221 can direct the communication interface 225 to transmit one or more packets in accordance with known techniques, e.g., in response to an indication of the packet to be sent from the resource allocation 219 process.

Accordingly, there is provided a method for ordering packets to be transmitted on a network, where a packet is to be transmitted on a channel to a communication device with a time offset between a shared control channel and a shared data channel. The method can be performed in the network infrastructure device 201, such as in the illustration, or other device appropriately arranged. A margin between a power need of a data channel of one or more packets and a total available transmit power of the network infrastructure device can be determined by, e.g., the margin determination 215. Scheduling 217 and/or resource allocation 219 can be performed, responsive to the margin, to determine one or more subsequent (or next) packets, wherein a control channel of the subsequent (or next) packets have a power need less than the power margin. The subsequent (or next) packet(s) are those which are intended to be transmitted immediately after the current packet is transmitted. The packet transmission 221 can cause the transmission of the subsequent (or next) packet(s) on the channel, wherein the data channel of the current packet(s) and the control channel of the subsequent packet(s) are at least partially contemporaneous. The data channel begins transmission after the pre-defined time offset, as determined by applicable standards. In accordance with HSDPA (High Speed Downlink Packet Access) standards, the data channel begins transmission about 1.333 ms after the control channel.

Alternative embodiments can provide for determining a predicted power need of the data channel and/or the control channel of a packet that is anticipated to follow the subsequent packet(s). The scheduler process 217 and/or the resource allocation process 219 can be responsive to the predicted power, and can include a balancing of the power need of the subsequent packet and a power need of the packet thereafter.

One or more embodiments provide for a preliminary determination of one or more subsequent packets to be transmitted after the current packets. Conventionally, allocation and/or scheduling of packets can be modified until the packets are sent. However, with the preliminary determination, one or more embodiments can predict what the allocation or scheduling is likely to be, and can adjust the scheduling and/or allocation of the current packets that are to be sent. For example, if the predicted power need of the control channel of the packet subsequent to the next packet is 15%, then the maximum allocated power for the data channel of the next packet should be at most 100%-15%=85%, which leaves an at least 15% power margin for the control channel of the packet subsequent to the next packet. However, the users to which packets are being sent can change from time-to-time. Accordingly, one or more embodiments further provides for preliminarily determining at least one third packet to be transmitted after the at least one second packet. This can be provided in combination with and/or as a part of the allocation and/or the scheduling.

Generally, the scheduler 217 determines the resources (e.g., communication devices or users, and packets that are to be sent) that are to be scheduled, as described above, whereas the resource allocation process 219 determines how those resources are to be distributed prior to transmission. Accordingly, one or more embodiments provides for performing an allocation of resources, responsive to the scheduling and the margin, wherein the transmitting is responsive to the allocation.

When the resources are allocated by the resource allocation process 219 or when scheduled by the scheduler 217, the allocation or scheduling can be responsive to the margin, to determine one or more packet(s) to be transmitted next, wherein a control channel of such packet(s) has a power need less than the power margin.

It can be advantageous to specifically consider reliable power needs. For example, minimum power can result in a minimally acceptable transmission to a particular communication device which may be subject to, e.g., being dropped. However, a reliable transmission (e.g., less likely to be dropped) may be more desirable by users and may be greater than a minimum power need. Thus, in addition to the margin, the resource allocation 219 and/or the scheduler 217 can take into consideration whether the power needs of a particular communication device for a reliable transmission are met (e.g., determined by using the C/I (carrier-to-interference ratio) reported from the communication device). Accordingly, the resource allocation 219 and/or scheduler 217 can be responsive to a power need for a reliable transmission of the data channel and the control channel to respective users.

Similarly, the resource allocation 219 and/or scheduler 217 can be responsive to a power need for a reliable transmission of the data channel and the control channel when more or less transmissions per packet are acceptable. By determining an acceptable range of targeted number of transmissions per packet then different amounts of power are made available for the associated control channel due to different amounts of being power required by the data channel. Alternatively, given a fixed power margin then different users can be accommodated by the margin by each choosing an appropriate number of transmissions per packet target provided it falls within an acceptable range for the required quality of service (QoS). This is similar to targeting a different FER or BLER for the first transmission of a packet or trading of QoS for increased latency and reduced power per packet transmission. This approach is more likely useful in systems that support soft combining of packet transmissions due to utilizing some form of Hybrid ARQ. In systems were the control channel is also soft combined then the power margin requirement can also reflect the different power requirements of the control channel if different number of transmissions are targeted.

One or more embodiments provide that one or more packets can be distributed on a channel at the same time, wherein each packet corresponds to a separate user. The packets can be distributed synchronously, e.g., where the frames have synchronous boundaries.

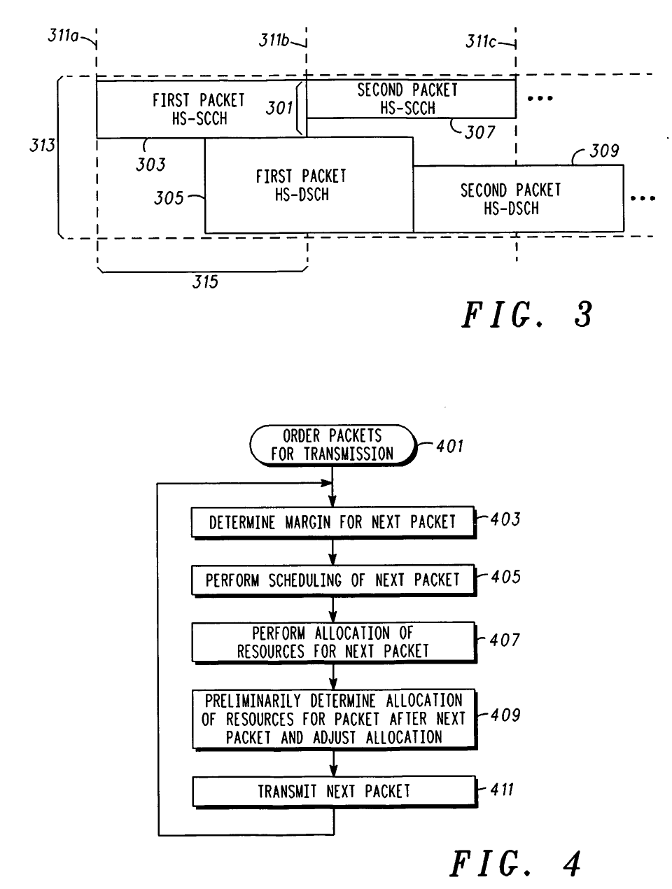

Referring now to FIG. 3, a diagram illustrating an exemplary and simplified representation of a downlink communication in accordance with various exemplary embodiments will be discussed and described. As shown in the illustrated example, in HSDPA, there is a total available power 313 for both HS-DSCH (high speed downlink shared channel) and HS-SCCH. In accordance with the HSDPA protocol, packets are sent on frame boundaries 311a-c. There is a time delay from transmission of the HS-SCCH (which begins at the frame boundary), e.g., first packet HS-SCCH 303 and second packet HS-SCCH 307, and the corresponding HS-DSCH (which begins at a pre-set time delay subsequent to the HS-SCCH), e.g., first packet HS-DSCH 305 and second packet HS-DSCH 309.

In time-delay packet transmission, such as HSDPA, for each frame 311a, 311b, 311c there is a time delay between the control channel (HS-SCCH) and the data channel (HS-DSCH) for high speed down link transmission. In this illustration, the first packet HS-SCCH and first packet HS-DSCH 303, 305 have been assigned resources to consume all available power.

However, for the second slot, due to the time overlap of the second slot HS-SCCH, e.g., a second packet HS-SCCH 307 and the first slot HS-DSCH, e.g., the first packet HS-DSCH 305, there is a constraint on the power available for the HS-SCCH. Specifically, a power need of the second packet HS-SCCH 307 combined with a power need of the first packet HS-DSCH 305 should be scheduled or allocated so as to not exceed the total available power 313. The difference between the total available power 313 and the first packet HS-DSCH 305 is referred to herein as the margin 301.

If the constraint of the margin is not added to a determination of scheduling and/or resource allocation, a certain amount of transmission power should be reserved so that a probability of transmitter power amplifier overload is negligible. Simulation tests suggest that up to 25% of transmission power should be reserved in conventional technology where the margin is not considered.

Referring now to FIG. 4, a flow chart illustrating an exemplary procedure 401 for ordering packets for a transmission in accordance with various exemplary and alternative exemplary embodiments will be discussed and described. The procedure can advantageously be implemented on, for example, a processor of a network infrastructure device, described in connection with FIG. 2 or other apparatus appropriately arranged.

A procedure 401 for ordering packets for transmission can provide for determining 403 the margin for the next packet or packets to be sent, as for example described previously. (The term “next packet” is used to distinguish from the packet currently being transmitted, and can include more than one packet.)

Scheduling 405 is performed, including scheduling the next packet or packets, where one or more packets are to be sent at the same frame to corresponding users. Alternatively, scheduling 405 can include scheduling particular users (corresponding to particular communication devices), e.g., based on priority as discussed above. Packets that will be sent correspond to the users. As described previously, the scheduling can include considering the power margin when determining which users or communication devices should be scheduled.

The process can perform 407 an allocation of resources for the next packet. As described previously, the allocation can include considering the power margin when determining how resources should be allocated.

The illustrated exemplary process includes a preliminary 409 determination of the allocation of resources for the packet subsequent to the next packet(s), and adjusting the allocation accordingly. The allocation can determine not only the next packet to be transmitted, but also can order the packets to be sent thereafter. Typically, however, this order is re-adjusted by the allocation each time it sends a packet (or packets) on a frame. The preliminary determination can check the order, and based on the order, can determine the power that would be required by the packets (or series of packets) subsequent to the next packet. The current allocation can be re-adjusted, for example, to approach an average power requirement. (The average can be determined over two or more packets.)

With the resources allocated, the process can provide for transmitting 411 the next packet. As described previously, the data portion of the packet is transmitted with a time delay. After beginning the transmission of the packet, the process loops and determines 403 the margin, based on the packet that was just transmitted.

As can be appreciated from the foregoing description, and in comparison with conventional scheduling and/or allocation which fails to consider the margin, one or more embodiments can reduce a possible HS-SCCH power overload at a network infrastructure device.

It should be noted that the term communication unit may be used interchangeably herein with subscriber unit, wireless subscriber unit, wireless subscriber device or the like. Each of these terms denotes a device ordinarily associated with a user and typically a wireless mobile device that may be used with a public network, for example in accordance with a service agreement, or within a private network such as an enterprise network.

The communication systems and communication units of particular interest are those providing or facilitating voice communications services or data or messaging services over cellular wide area networks (WANs), such as various cellular phone systems including digital cellular, CDMA (code division multiple access) and variants thereof, 3 G and 3.5 G systems such as UMTS (Universal Mobile Telecommunication Service) systems with HSDPA (High Speed Downlink Packet Access) and variants or systems evolving therefrom.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for ordering packets to be transmitted on a network, where a packet is to be transmitted on a channel to a communication device with a time offset between a shared control channel and a shared data channel, the method being performed in a network infrastructure device, comprising:
determining a margin between a power need of a data channel of at least one first packet and a total available transmit power of the network infrastructure device;
performing a scheduling, responsive to the margin, to determine at least one second packet, wherein a control channel of the at least one second packet has a power need less than the power margin; and
transmitting the at least one second packet on the channel, wherein the data channel of the at least one first packet and the control channel of the at least one second packet are at least partially contemporaneous.

2. The method of claim 1, further comprising determining a predicted power need of at least one of a data channel and a control channel of a third packet;
wherein the performing is further responsive to the predicted power and further comprises a balancing of the power need of the second packet and a power need of the third packet.

3. The method of claim 2, wherein the performing further comprises preliminarily determining at least one third packet to be transmitted after the at least one second packet.

4. The method of claim 1, wherein performing the scheduling, responsive to the margin, to determine at least one second packet also includes accounting for different power needs of a second packet when a targeted number of transmissions is varied.

5. The method of claim 1, wherein the network is a high speed downlink packet access (HSDPA) network.

6. The method of claim 1, wherein the scheduling further comprises determining a priority of users on the network infrastructure device.

7. The method of claim 1, further comprising performing an allocation of resources, responsive to the scheduling and the margin, wherein the transmitting is responsive to the allocation.

8. The method of claim 7, wherein the allocation further is responsive to a power need of a reliable transmission of at least one data channel and at least one control channel to respective users.

9. The method of claim 1, wherein a plurality of packets are distributed on a channel at a same time, wherein each packet corresponds to a separate user.

10. A method for ordering packets to be transmitted on a network, where a packet is to be transmitted on a channel to a communication device with a time offset between a shared control channel and a shared data channel, the method being performed in a network infrastructure device, comprising:
determining a margin between a power need of a data channel of at least one first packet and a total available transmit power of the network infrastructure device;
performing an allocation of resources, responsive to the margin, to determine at least one second packet, wherein a control channel of the at least one second packet has a power need less than the power margin; and
transmitting the at least one second packet, wherein the data channel of the at least one first packet and the control channel of the at least one second packet are at least partially contemporaneous.

11. The method of claim of, further comprising determining a predicted power need of at least one of a data channel and a control channel of a third packet;
wherein the performing is further responsive to the predicted power and further comprises a balancing of the power need of the second packet and a power need of the third packet.

12. The method of claim 11, wherein the performing further comprises preliminarily determining at least one third packet to be transmitted after the at least one second packet.

13. The method of claim 10, wherein performing an allocation of resources, responsive to the margin, to determine at least one second packet further includes accounting for different power needs of a second packet when a targeted number of transmissions is varied over a predetermined range.

14. The method of claim 10, wherein the network is a high speed downlink packet access (HSDPA) network.

15. The method of claim 10, wherein the allocation further is responsive to a power need of a reliable transmission of at least one data channel and at least one control channel to respective users.

16. The method of claim 10, wherein a plurality of packets are distributed on a channel at a same time, wherein each packet corresponds to a separate user.

17. A network infrastructure device for transmitting packets on a network, where a packet is to be transmitted on at least one channel to a communication device with a time offset between a shared control channel and a shared data channel, wherein the network infrastructure device has a transmit power, comprising:
a margin determination unit, to determine a margin between a power need of a data channel of at least one first packet and a total available portion of the transmit power;
a scheduler, responsive to the margin, to determine at least one user corresponding to at least one second packet to be transmitted, wherein a control channel of the at least one second packet has a power need less than the power margin;
a resource allocation unit, responsive to the margin and to the scheduler, to perform an allocation of resources including the at least one channel, providing the at least one second packet; and
a transmitter, responsive to the resource allocation unit, to transmit the at least one second packet, wherein the data channel of the at least one first packet and the control channel of the at least one second packet are at least partially contemporaneous.

18. The network infrastructure device of claim 17, wherein the resource allocation unit further determines a predicted power need of at least one of a data channel and a control channel of a third packet, wherein the allocation is further responsive to the predicted power and balances the power need of the second packet and a power need of the third packet.

19. The method of claim 17, wherein the scheduler, responsive to the margin, to determine at least one user corresponding to at least one second packet to be transmitted, further accounts for different power needs of a second packet to be transmitted when the targeted number of transmissions is varied over an acceptable range.

20. The network infrastructure device of claim 17, wherein the network is a high speed downlink packet access (HSDPA) network.
